(19) United States
(12) Patent Application Publication
(10) Pub. No.: US 2005/0048208 A1
(43) Pub. Date: Mar. 3, 2005

(54) Resist supply apparatus with resist recycling function, coating system having the same and method of resist recycling

(76) Inventors: Yao-Hwan Kao, Hsinchu-Hsien (TW); Ko-Bin Kao, Taichung Hsien (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/653,298

(22) Filed: Sep. 2, 2003

(51) Int. Cl. B05D 3/12; B05C 5/00; B05C 11/00

(52) U.S. Cl. 427/345; 427/444; 118/696; 118/300

(57) ABSTRACT

A system for resist recycling includes a supply tank for storing a resist, a supply line connecting the supply tank with a pump therein for transferring the resist, a nozzle connected to the supply line for dispensing a predetermined dosage of the resist, and a recycle tank for receiving the predetermined dosage of dummy resist dispensed by the nozzle. The dummy resist is dispensed to prevent crystallized resist at the nozzle. A recycle line is disposed between the recycle tank and the supply tank for recycling the resist received by the recycle tank to the supply tank. The system can further include a coating system working in cooperation with the resist recycling system. Other systems and methods are also provided.

### BACKGROUND OF THE INVENTION

1. Field of the Invention

The present invention relates to a semiconductor fabricating system with a recycling function, and in particular to a resist supply apparatus with resist recycling function and a coating system having the same such that dummy resist thereof can be recycled.

2. Description of the Related Art

Photolithography is generally used in the fabricating of semiconductor devices. Coating methods such as spin coating are commonly used for forming resist thin film therein. In a typical spin coating, liquid resist is applied to a semiconductor substrate, for example silicon wafer, by a nozzle of a resist supply apparatus. After spinning, only a thin film of the resist is left on the surface of the wafer.

Nevertheless, crystal defects can sometimes be found on a coated substrate that affects the accuracy of subsequent photolithography. Normally, crystal defects are formed by crystallized resist found at the nozzle tip, referred to as “crystallized nozzle tip issue” due to evaporation of resist adjacent thereto exposed to ambient atmosphere for a long idle time (normally over 30 minutes). The described issue can occur with all resist types. Hence, one common solution is to periodic supply a predetermined dosage (normally 1-2 cm³) of the resist to flush off any crystals formed adjacent to the nozzle tip. Thus, possible resist crystallization at the nozzle tip can be avoided. Typically, dosages of the resist dispensed in this procedure are directly drained to a waste fluid system. The resist dispensed is referred to hereinafter as dummy resist.

Table 1 shows costs in approximate US$ amounts for different resist uses from August to October 2002 for fifteen systems coating wafers of 300 mm diameter in one fab of Taiwan Semiconductor Manufacturing Company (TSMC).

TABLE 1

| Cost (US$) | | | | |
|---|---|---|---|---|
| (In thousands) | Aug. | Sep. | Oct. | Avg. cost |
| Production | 539.4 | 645.73 | 649.70 | 611.66 |
| Dummy resist | 187.78 | 200.14 | 212.21 | 200.05 |
| Maintenance | 176.15 | 203.60 | 203.60 | 194.46 |
| Tool | 61.95 | 83.17 | 10.02 | 51.73 |
| installation | | | | |
| Control wafers | 26.55 | 28 | 29.45 | 64.78 |
| Total cost | 991.77 | 1160.80 | 1105.05 | 745.06 |

Also shown are costs of different resist uses such as production, maintenance, new tool installation, control wafers, and dummy resist used to eliminate crystallized nozzle tip issue. Average monthly cost for dummy resist is about US$200,050 and occupies 26.9% of the total costs of the photolithography.

The resist dispensed for dummy use considerably increases the costs of a fabricating process and occupies significant percentages of total cost for one photolithography section.

Hence, there is a need for a technique to recycle the dummy resist.

U.S. Pat. No. 6,503,568 Oota et Al. disclose a resist recycling apparatus and method for sufficiently controlling the viscosity of a resist to allow reuse of recycled resist in the manufacture of a semiconductor device. As disclosed the resist recycled is spun off during spin coating, and not dispensed for dummy use.

### SUMMARY OF THE INVENTION

Accordingly, an object of the invention is to provide a resist supply apparatus with a resist recycling function that recycles dummy resist dispensed to prevent crystallized nozzle tip issue and a coating system utilizing the same.

Another object of the invention is to provide a method of recycling dummy resist dispensed to prevent nozzle tip crystallized issue.

To achieve the foregoing and other objects, the invention is directed to novel systems and methods for overcoming conventional dummy resist recycling methods. In one embodiment of the system, among others, can be implemented to include a resist supply apparatus with resist recycling function. The apparatus includes a supply tank for storing a resist, a supply line connecting the supply tank for transferring the resist, a nozzle connected to the supply line for dispensing a predetermined dosage of the resist, and a recycle tank for receiving the predetermined dosage of dummy resist dispensed by the nozzle. Preferably, the dummy resist is dispensed to prevent crystallized resist at the nozzle. A recycle line is preferably disposed between the recycle tank and the supply tank for recycling the resist received by the recycle tank to the supply tank.

In a preferred embodiment of the invention, the recycle tank receives dummy resist dispensed to prevent crystallized resist at the nozzle. High and low level sensors can be disposed in the recycle tank for monitoring a liquid level therein. A filter and a control valve can also be disposed in the recycle line and signal connections are respectively set between the high level sensor and the low level sensor to the control valve. Further, the filter preferably removes impurities, such as crystals in the resist received by the recycle tank. In a preferred embodiment, particles larger than 0.05 μm are removed by the filter.

An alternative preferred embodiment of the invention includes a coating system having a resist supply apparatus with a resist recycling function. The coating system includes the resist supply apparatus supplying a resist and a coating apparatus with a substrate thereon for receiving and distributing the resist onto the substrate.

The present invention can also be viewed as providing methods for resist recycling. In this regard, one embodiment of such a method, among others, can be broadly summarized by the following steps: providing a resist supply apparatus with resist recycling function; dispensing a predetermined dosage of the resist from a supply tank to a recycle tank by the nozzle thereof every predetermined time interval; and transferring the resist received by the recycle tank to the supply tank for resist recycling.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a preferred embodiment of a coating system having the resist supply apparatus with a resist recycling function.

FIG. 2 is a flow chart depicting general functionality, in accordance with one preferred embodiment, of an implementation of resist recycling.

### DETAILED DESCRIPTION OF THE INVENTION

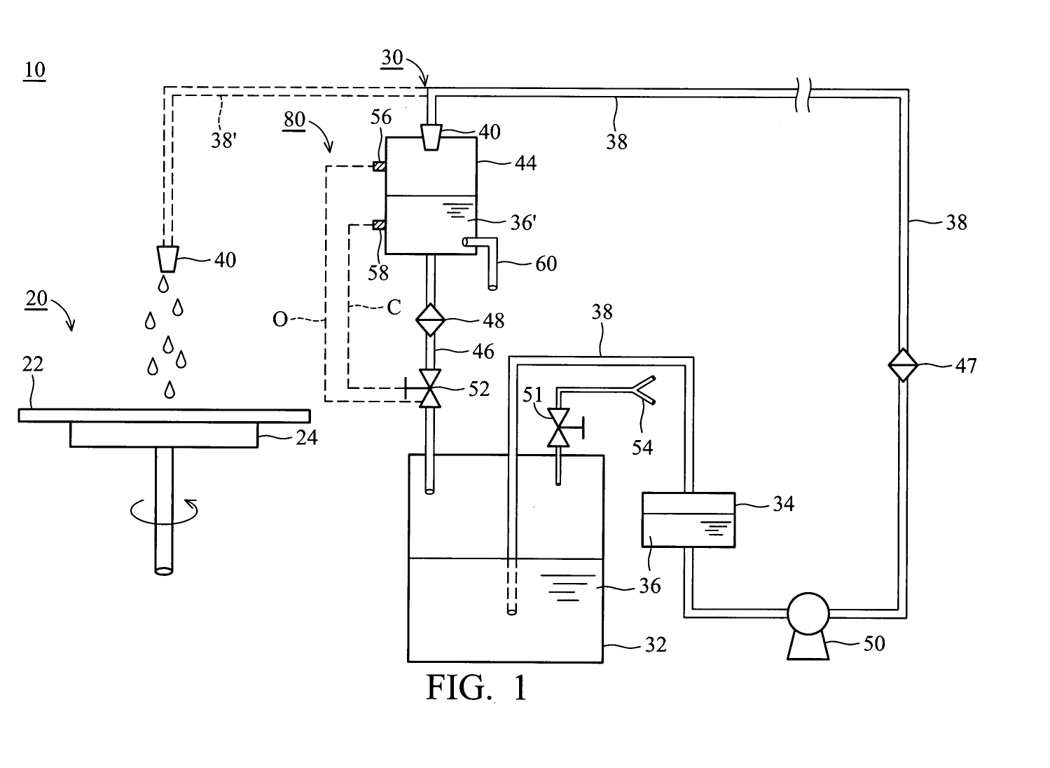

Disclosed herein are novel systems and methods for resist recycling. To facilitate description of the inventive system, an example system that can be used to implement the resist recycling is discussed with reference to the figures. Although this system is described in detail, it will be appreciated that this system is provided for purposes of illustration only and that various modifications are feasible without departing from the inventive concept. After the example system has been described, an example of operation of the system will be provided to explain the manner in which the system can be used to provide resist recycling. Referring now in more detail to the drawings, FIG. 1 is a schematic diagram depicting a preferred embodiment of a coating system having a resist supply apparatus with resist recycling function.

In a preferred embodiment of the invention, the coating system 10 includes a coating apparatus 20 and a resist supply apparatus 30 with a resist recycling device 80.

In a preferred embodiment, the coating apparatus 20, is a spin coater 20. The coating apparatus 20, includes a substrate 22 disposed on a rotational chuck 24, to receive a coated thin resist film. Other components can be included in the spin coater 20, such as a controller (not shown) for controlling the speed of the chuck 24, a waste fluid system (not shown) for receiving resist spun off from the substrate 22, and a housing (not shown) covering the components. These components are not shown in FIG. 1, for simplicity.

The coating apparatus 20 is not limited to the spin coater 20, and can utilize other types of coating apparatuses such as roller coating apparatus (not shown) among others.

In a preferred embodiment, the resist supply apparatus 30 includes a main supply tank 32 for storing large amounts of a resist liquid 36, a buffer supply tank 34 for storing smaller amounts of the resist 36 supplied from the main supply tank 32, a supply line 38 for transferring the resist 36, and a nozzle 40 connected to the supply line 38 for dispensing a predetermined dosage of the resist 36.

In an alternative preferred embodiment, an additional resist recycling device 80 is further disposed in the resist supply apparatus 30.

In an example, during a coating process, the nozzle 40 attached to supply line 38′ is positioned adjacent to spin coater 20 for dispensing a predetermined dosage of the resist 36 onto a substrate 22. The nozzle 40 can be intermittently disposed upon the resist recycling device 80 for periodically dispensing predetermined dosages of the resist 36 to prevent a crystallized nozzle tip issue.

The recycling device 80 includes a recycle tank 44 for receiving the resist dispensed from the nozzle 40, shown as a resist dispensed 36′ hereinafter, and a recycle line 46 connecting the recycle tank 44 and the main supply tank 32 for transferring the resist dispensed 36′ in the recycle tank 44 to the main supply tank 32. In an example, the resist dispensed 36′ is utilized in subsequent photolithography and can be recycled in the resist supply apparatus 30.

Fittings such as in-line filters 47 and 48, circulation pump 50 and control valves 51 and 52 are included at proper locations in the supply line 38 and the recycle line 46 and are not restricted to the configuration shown in FIG. 1.

In addition, a nitrogen supply line 54 connecting the main supply tank 32 to supply N₂ gas (not shown) thereinto prevents resist 36 therein from exposure to the ambient atmosphere which can possibly affect the chemical properties of the resist 36.

Moreover, in the resist recycling device 80, a high level sensor 56 and a low level sensor 58 are disposed onto the recycle tank 44 to monitor a liquid level therein. In an example, the control valve 52 disposed in the recycle line 46 is a solenoid valve or an air valve having signal connections to those level sensors 56, 58. A cap (not shown) can be included on the recycle tank 44 to prevent contamination from an ambient environment. A drain line 60 is disposed near the bottom of the recycle tank 44 to drain the resist during maintenance.

In an example of operation of the resist recycling device 80, once the resist dispensed 36′ received by the recycle tank 44 reaches a high liquid level, a signal O is sent from the high level sensor 56 to open the control valve 52. The opening control valve 52 allows the resist dispensed 36′ to flow through the recycle line 46 and into the main supply tank 32. When the resist dispensed 36′ in the recycle tank 44 reaches a low liquid level therein, a signal C is sent from the low level sensor 58 to close the control valve 52. The closed control valve 52 prevents the dispensed resist 36′ to flow through the recycle line 46 and into the main supply tank 32. The filter 48 disposed in the recycle line 46 removes impurities, for example crystals or other particles, in the resist dispensed 36′. Preferably, the filter 48 removes impurities with a pore size larger than 0.05 μm.

Resist dispensed 36′ from the nozzle 40 every predetermined time interval prevents the nozzle tip crystallization issue and provides for receiving, recycling, and transferring the resist dispensed 36′ to the main supply tank 32 for subsequent photolithography. The recycled resist 36′ in the recycle tank 44 can be reused on a substrate 22 by other coating processes by the coating apparatus 20.

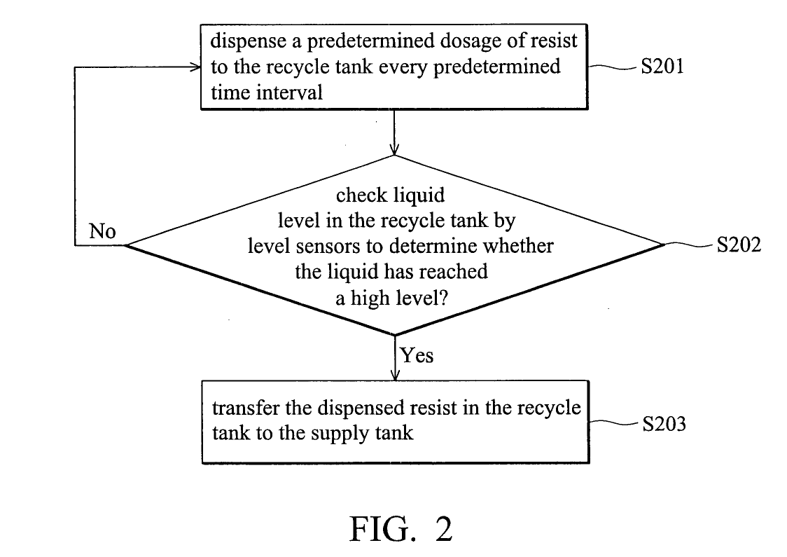

FIG. 2 is a flow chart depicting general functionality (or method), in accordance with one preferred embodiment, of an implementation of resist recycling. In an example, a coating system for photolithography process includes a coating apparatus and at least one resist supply apparatus. Some coating systems include a plurality of resist supply apparatuses to supply a plurality of types of resist for different photolithography processes.

By periodically dispensing a predetermined dosage of the resist thereof the crystallized nozzle tip issue at each nozzle thereof can be substantially eliminated.

Initially, a resist supply apparatus, for example a resist supply apparatus 30 with resist recycling function, is provided to the process. At step S201, a predetermined dosage, normally between 1 cm³ and 2cm³, of the resist 36 is preferably dispensed from a supply tank to the recycle tank by the nozzle to flush the nozzle every predetermined time interval to avoid resist crystallization adjacent to the tip of the nozzle. The dispensed resist received by the recycle tank may include impurities such as crystals or other particles from the environment. Preferably, the predetermined time interval is between 5 and 30 minutes, which is less than the time (normally over 30 minutes) it takes for the resist exposed to the ambient atmosphere to become crystallized.

Step S202 determines whether the resist dispensed received by the recycle tank has reached a high liquid level in the recycle tank. If not, the resist dispensed remains in the recycle tank and step S201 is repeated again to dispense other dosages of the resist during the next time interval. If the resist dispersed has reached a high level, at step S203, a high level sensor sends an open signal to the control valve disposed in the recycle line connecting the recycle tank and the supply tank (for example the main supply tank) to turn on the control valve and allow the resist dispensed to flow into the supply tank (for example the main supply tank). Thus, resist dispensed for dummy resists used to eliminate crystallized nozzle tip issue, can be entirely recycled and costs saving realized.

According to the novel resist recycling function of a resist supply apparatus of the prevent invention, a coating system can recycle the dummy resist and reduce or eliminate associated costs.

The resist recycling device comprising the recycle tank, the level sensors, the recycle line, the filter and the control valve is integrated into the resist supply apparatus to provide a novel resist recycling function.

In addition, the crystallized nozzle tip issue can be significantly reduced or eliminated by the resist supply apparatus and a coating system in accordance with the present invention. A significant reduction in crystal defects on a coated substrate will be achieved, accuracy of subsequent photolithography elevated, and the coated resist film uniformity improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A resist supply apparatus, comprising:
a supply tank for storing a resist;
a supply line connecting the supply tank for transferring the resist;
a nozzle connected to the supply line for dispensing a predetermined dosage of the resist;
a recycle tank for receiving an amount of a dummy resist dispensed by the nozzle, wherein the dummy resist is dispensed to prevent crystallized resist at the nozzle; and
a recycle line disposed between the recycle tank and the supply tank for recycling the resist received by the recycle tank to the supply tank.

2. The apparatus as claimed in claim 1, wherein the supply tank is a main supply tank.

3. The apparatus as claimed in claim 1, wherein the recycle tank further comprises high and low level sensors disposed in the recycle tank for monitoring a liquid level therein.

4. The apparatus as claimed in claim 3, wherein the recycle line further comprises a filter and a control valve disposed in the recycle line and signal connections set between the high level sensor and the low level sensor to the control valve.

5. The apparatus as claimed in claim 4, wherein the control valve is an air valve or solenoid valve.

6. The apparatus as claimed in claim 4, wherein the filter is configured to remove impurities from the resist received by the recycle tank including particles larger than 0.05 μm.

7. The apparatus as claimed in claim 6, wherein the impurities are crystals of the resist.

8. The apparatus as claimed in claim 1, wherein the supply line further comprises a pump for transferring the resist.

9. A method of resist recycling, comprising the steps of:
dispensing of a predetermined dosage of a resist from a supply tank to a recycle tank through a nozzle at predetermined time intervals; and
transferring the resist received by the recycle tank to the supply tank for resist recycling.

10. The method as claimed in claim 9, the dispensing step is performed wherein the predetermined time interval is between 5 and 30 minutes.

11. The method as claimed in claim 9, the dispensing step is performed with the predetermined dosage of the resist is between 1 cm³ and 2 cm³.

12. The method as claimed in claim 9, wherein the transferring step is performed with resist received by the recycle tank is further configured as dummy resist for preventing crystallized resist at the nozzle.

13. The method as claimed in claim 9, further comprising providing the recycle tank with high and low level sensors disposed thereon for monitoring a liquid level therein.

14. The method as claimed in claim 13, further comprising providing a recycle line having a filter and a control valve disposed in the recycle line, and signal connections set between the high level sensor and the low level sensor to the control valve.

15. The method as claimed in claim 14, the providing step is performed with control valve comprising an air valve or solenoid valve.

16. The method as claimed in claim 14, wherein providing step is performed with filter removing impurities of the resist received by the recycle tank with removal of particles larger than 0.05 μm.

17. The method as claimed in claim 16, wherein the filter is configured to remove impurities that crystals of the resist.

18. A coating system having a resist supply apparatus, comprising:
a supply tank for storing a resist;
a supply line connecting the supply tank for transferring the resist;
a nozzle connected to the supply line for dispensing a predetermined dosage of the resist;
a recycle tank for receiving an amount of a dummy resist dispensed by the nozzle, wherein the dummy resist is dispensed to prevent crystallized resist at the nozzle;
a recycle line disposed between the recycle tank and the supply tank for recycling the resist received by the recycle tank to the supply tank; and
a coating apparatus with a substrate thereon for receiving and distributing the resist onto the substrate.

19. The system as claimed in claim 18, wherein the substrate is disposed on a chuck.

20. The system as claimed in claim 18, wherein the recycle tank further comprises high and low level sensors disposed in the recycle tank for monitoring a liquid level therein.

21. The system as claimed in claim 20, wherein the recycle line further comprises a filter and a control valve disposed in the recycle line, and signal connections set between the high level sensor and the low level sensor to the control valve.

22. The system as claimed in claim 21, wherein the control valve is an air valve or solenoid valve.

23. The system as claimed in claim 21, wherein the filter is configured to remove impurities of the resist received by the recycle tank including particles larger than 0.05 μm.

24. The system as claimed in claim 23, wherein the impurities are crystals of the resist.

25. The system as claimed in claim 18, wherein the supply line further comprises a pump for transferring the resist.
